(19) United States
(12) Patent Application Publication
(10) Pub. No.: US 2019/0249810 A1
(43) Pub. Date: Aug. 15, 2019

(54) Method for Attaching an End-Seal Fitting to a Lined Host Pipe

(71) Applicant: Jeffrey M. Tanner, Zanesville, OH (US)

(72) Inventor: Jeffrey M. Tanner, Zanesville, OH (US)

(21) Appl. No.: 15/897,392

(22) Filed: Feb. 15, 2018

(51) Int. Cl. F16L 55/16; F16L 21/06; F16L 15/04

(52) U.S. Cl. CPC F16L 55/1608; F16L 15/04; F16L 21/065

(57) ABSTRACT

A method for attaching an end-seal fitting to a lined host pipe. The end-seal fitting generally includes a lined host pipe, comprising an end; a female threaded compression end disposed around the end of the lined host pipe; a rubber gasket disposed around the lined host pipe and within the female threaded compression end; a rubber gasket sleeve seated on the edge of the end of the lined host pipe; a stiffener sleeve seated within the rubber gasket sleeve and on the edge of the end of the lined host pipe; a male threaded compression end that is threadably attached to the female threaded compression end; and wherein the attachment between the female threaded compression end and the male threaded compression end keeps the rubber gasket, the rubber gasket sleeve, and the stiffener sleeve in a substantially fixed position.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to attaching an end-seal fitting to a lined host pipe

### Related Art

Any discussion of the related art throughout the specification should in no way be considered as an admission that such related art is widely known or forms part of common general knowledge in the field.

One method of repairing a damaged pipe is to insert a liner which seals the pipe from intrusion from outside contaminants and avoids seepage from inside the pipe to the surrounding soil. One of the advantages of using a liner is that it does not require excavation of the pipe in many circumstances. However, a pipe that has been repaired with a liner can receive additional damage that requires its own repairs. In addition, it may be necessary or desirable to modify a section of a lined host pipe to add a branch line, for example Typical methods of fixing lined pipes include falling back to pre-liner techniques such as excavating the entire pipe and replacing it with new pipe. Alternatively, a new liner can be added to the already lined pipe to fix the new damage. However, this has the problem of further constricting the flow within the pipe as additional layers are added. Moreover, to the extent that the problem is localized to a specific region it may be preferable to fix this specific area rather than add a new layer to the entire pipe. Similarly, the addition of a branch line is a localized concern at the desired branch point. Thus, there is needed a method for replacing or repairing a section of a lined host pipe.

### SUMMARY

An example embodiment is directed to a method for repairing a lined host pipe using an end-seal fitting. The end-seal fitting generally includes a lined host pipe, comprising an end; a female threaded compression end disposed around the end of the lined host pipe; a rubber gasket disposed around the lined host pipe and within the female threaded compression end; a rubber gasket sleeve seated on the edge of the end of the lined host pipe; a stiffener sleeve seated within the rubber gasket sleeve and on the edge of the end of the lined host pipe; a male threaded compression end that is threadably attached to the female threaded compression end; and wherein the attachment between the female threaded compression end and the male threaded compression end keeps the rubber gasket, the rubber gasket sleeve, and the stiffener sleeve in a substantially fixed position.

There has thus been outlined, rather broadly, some of the embodiments of the pipe liner end seal fitting in order that the detailed description thereof may be better understood, and in order that the present contribution to the art may be better appreciated. There are additional embodiments of the pipe liner end seal fitting that will be described hereinafter and that will form the subject matter of the claims appended hereto. In this respect, before explaining at least one embodiment of the pipe liner end seal fitting in detail, it is to be understood that the pipe liner end seal fitting is not limited in its application to the details of construction or to the arrangements of the components set forth in the following description or illustrated in the drawings. The pipe liner end seal fitting is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is an exploded perspective view of a lined host pipe with an end-seal fitting in accordance with an example embodiment.

FIG. 2 is an exploded cross-section view of a lined host pipe with an end-seal fitting in accordance with an example embodiment.

FIG. 3 is a cross-section view of a lined host pipe with an end-seal fitting in accordance with an example embodiment

FIGS. 4A-4D show a perspective view of the assembly of a lined host pipe with an end-seal fitting in accordance with an example embodiment.

FIG. 5 is an exploded perspective view of a lined host pipe with an end-seal fitting in accordance with an alternate embodiment.

FIG. 6 is an exploded cross-section view of a lined host pipe with an end-seal fitting in accordance with an alternate embodiment.

FIG. 7 is a cross-section view of a lined host pipe with an end-seal fitting in accordance with an alternate embodiment.

FIG. 8 is a close-up view of the region identified as “VIII” in FIG. 7.

FIGS. 9A-9D show a perspective view of the assembly of a lined host pipe with an end-seal fitting in accordance with an alternate embodiment.

### DETAILED DESCRIPTION

### A. Overview

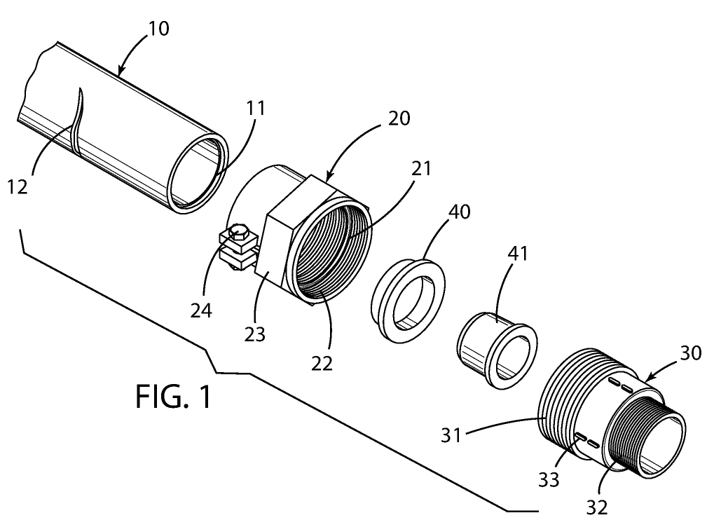

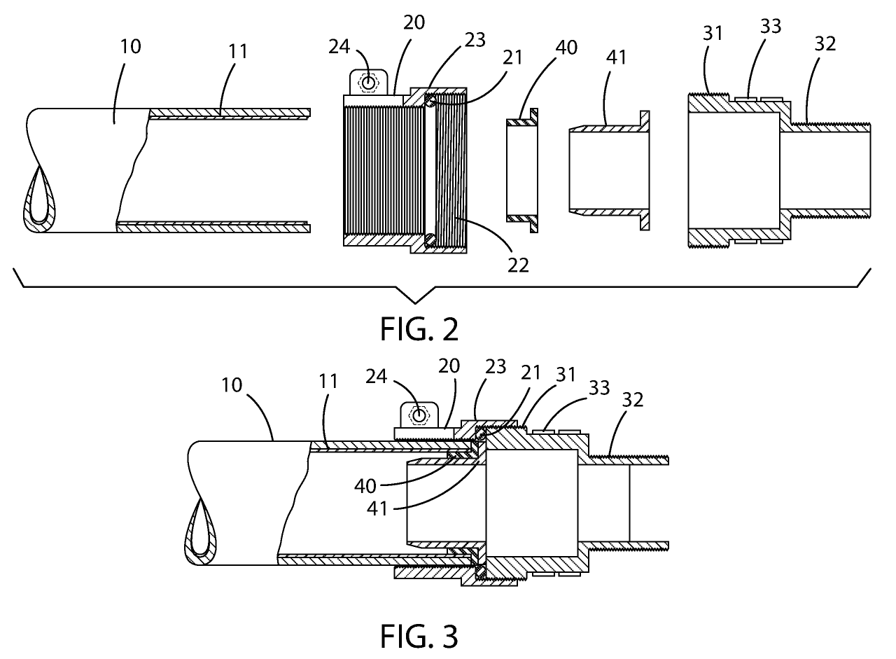

Turning now descriptively to the drawings, in which similar reference characters denote similar elements throughout the several views, FIGS. 1 through 4D illustrate the configuration and assembly of an example embodiment. An example lined pipe end-seal fitting generally comprises a lined host pipe 10, a female threaded compression end 20 disposed around the end of the lined host pipe 10; a rubber gasket 21 disposed around the lined host pipe 10 and within the female threaded compression end 20; a rubber gasket sleeve 40 seated on the edge of the end of the lined host pipe 10; a stiffener sleeve 41 seated within the rubber gasket sleeve 40 and on the edge of the end of the lined host pipe 10; a male threaded compression end 30 that is threadably attached to the female threaded compression end 20; and wherein the attachment between the female threaded compression end 20 and the male threaded compression end 30 keeps the rubber gasket 21, the rubber gasket sleeve 40, and the stiffener sleeve 41 in a substantially fixed position. The female threaded compression end 20 generally comprises female threads 22, a nut-shaped region 23 and a locking bolt 24. The male threaded compression end 30 generally comprises male threads 31, fitting threads 32 and a grip 33.

### B. End-Seal Fitting

An example end-seal fitting generally comprises a female threaded compression end 20 and a male threaded compression end 30. In this example embodiment, the female threaded compression end 20 fits over an end of a lined host pipe 10. However, it is possible to reverse the genders of the compression ends 20, 30. Other types of compression fittings can also be used that utilize latches, clamps or screws, for example.

In the example embodiment shown in FIGS. 1 to 4D, female threaded compression end 20 comprises a rubber gasket 21 that is used to create a seal between female threaded compression end 20 and male threaded compression end 30, as shown in FIG. 3, for example. Female threads 22 are adapted to couple with male threads 31 on the male threaded compression end 30. Female threaded compression end 20 may also contain a hexagonal nut-shaped region 23 to enable the use of a wrench to prevent the female threaded compression end 20 from routing when the male threaded compression end 30 is tightened. The female threaded compression end 20 may also contain a locking bolt 24, which can be used to tighten the female threaded compression end 20 around the end of lined host pipe 10. Generally, locking bolt 24 is part of a collar around or within female threaded compression end 20 that when tightened causes the female threaded compression end 20 to squeeze around the lined host pipe 10. In some embodiments, locking bolt 24 and its associated mechanism are integrated with the female threaded compression end 20. In other embodiments, locking bolt 24 is part of a separate structure. Locking bolt 24 may prevent translation of female threaded compression end 20 along lined host pipe 10 and/or rotation around the circumference of lined host pipe 10.

In this example embodiment, male threaded compression end 30 comprises male threads 31, fitting threads 32 and a grip 33. Male threads 31 are adapted to couple with female threads 22 on the female threaded compression end 20. In general, the male threaded compression end 30 rotates when it is coupled to the female threaded compression end 20, which is substantially stationary. Coupling between the compression ends 20, 30 can be assisted with the aid of a wrench disposed on nut 23. Typically, male threaded compression end 30 is tightened by hand. However, other embodiments may include machine tightening or use of other tools. In still other embodiments, only a portion of female threaded compression end 20 or male threaded compression end 30 may be configured to rotate. For embodiments that utilize clamps, neither female threaded compression end 20 nor male threaded compression end 30 may be configured to rotate. Female threaded compression end 20 and male threaded compression end 30, may comprise commonly available brass fittings, such as those provided by A.Y. McDonald Mfg. Co or Ford Meter Box Company, Inc.

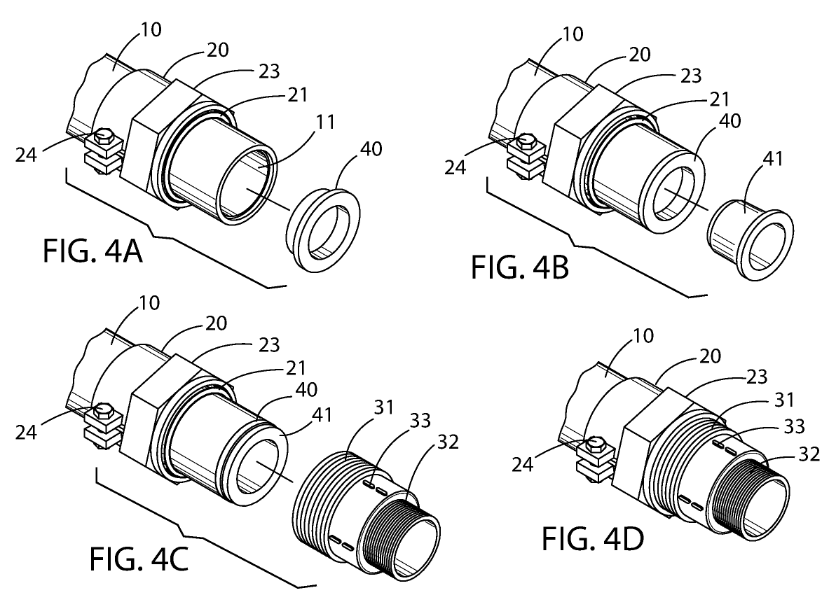

A rubber gasket sleeve 40 and a stiffener sleeve 41 may be disposed within the end of lined host pipe 10. In general, rubber gasket sleeve 40 sits within the end of lined host pipe 10, and generally comprised of a moderately compressible form of rubber. As shown in FIGS. 3 and 4B, rubber gasket sleeve 40 comprises a lip that is generally flush with the edge of lined host pipe 10. The exterior of rubber gasket sleeve 40 is in contact with liner 11 of lined host pipe 10. In general, the outer ring of the rubber gasket 40 is flush with the exterior of lined host pipe 10. If necessary, rubber gasket sleeve 40 can be trimmed such that it is flush. In addition, the underside of rubber sleeve 40 is generally flush with the end of lined host pipe 10. If necessary, liner 11 can be trimmed back slightly to permit a tight seal between rubber gasket sleeve 40 and the lined host pipe 10.

Stiffener sleeve 41 is disposed within rubber gasket sleeve 40 to create a tight seal between the interior of lined host pipe 10 and the exterior of the internal portion of rubber gasket sleeve 40. As such, the insertion of stiffener sleeve 41 will compress rubber gasket sleeve 40 within lined host pipe 10. As shown in FIG. 3, stiffener sleeve 41 compresses rubber gasket sleeve 40 against liner 11 within lined host pipe 10. The combination of female threaded compression end 20 and male threaded compression end 30 compress the lip of stiffener sleeve 41 against the lip of rubber gasket sleeve 40. Rubber gasket 21 adds additional water tight sealing as well as prevents stripping of either female threads 22 or male threads 31.

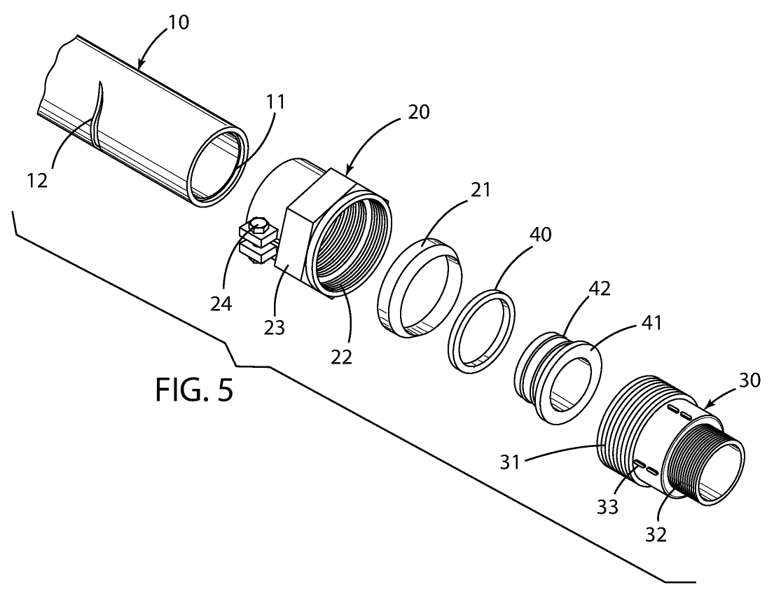

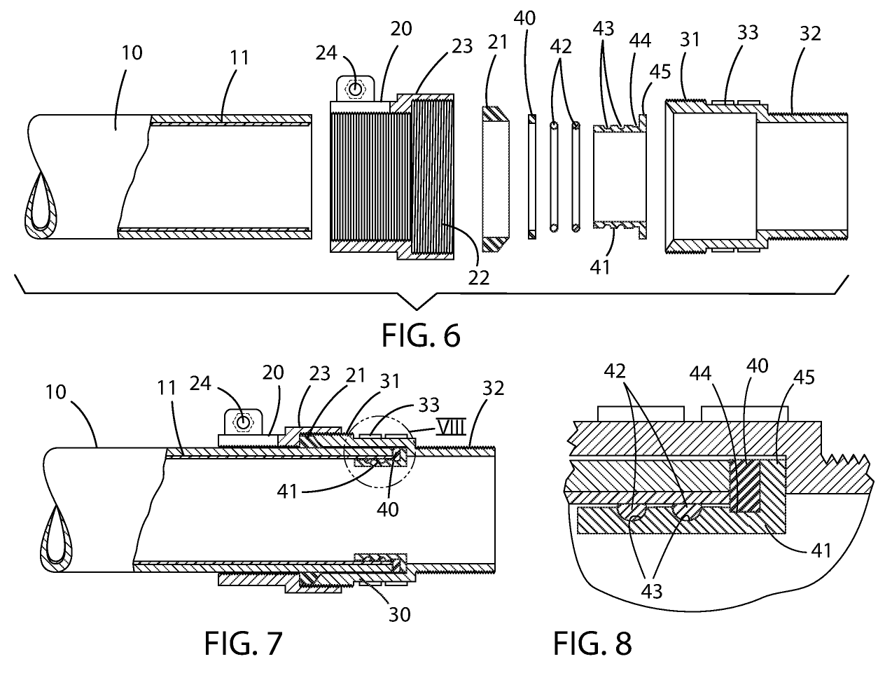

An additional embodiment is shown in FIGS. 5 to 9D. A cross-section of a completed version of this embodiment is shown in FIGS. 7 and 8. In this embodiment, stiffener sleeve 41 is disposed within lined host pipe 10, and rubber gasket sleeve 40 is a ring that sits between the end of lined host pipe 10 and the underside of lip 45 of stiffener sleeve 41. In this embodiment, stiffener sleeve 41 comprises a notch 44 that is adapted to receive rubber gasket sleeve 40. In this embodiment, stiffener sleeve 41 also contains a plurality of groves 43 that are each adapted to receive an O-ring 42. O-rings 42 enable a tighter fit between stiffener sleeve 41 and the interior of lined host pipe 10. In other embodiments, the external shape of O-rings 42 can be directly integrated into stiffener sleeve 41 as ridges. Although there is some correspondence between grooves 43 and O-rings 42, grooves 43 may be adapted to receive more than one size of O-ring 42 or to receive other shapes. In this embodiment, stiffener sleeve 41 is compressed against the interior of male threaded compression end 30, wherein the combination of rugger gasket sleeve 40 and stiffener sleeve 41 create a water tight seal within male threaded compression end 30.

In this embodiment, as shown in FIG. 7, lined host pipe 10 is inserted within male threaded compression end 30 so that the edge of stiffener sleeve 41 rests against an interior lip within male threaded compression end 30. In addition, rubber gasket 21 and the end of male threaded compression end 30 are beveled in complementary manners. In this particular embodiment, the beveling comprises narrowing the external diameter of rubber gasket 21 as it approaches the end of lined host pipe 10. In other embodiments the external diameter of rubber gasket 21 may broaden as it approaches the end of lined host pipe 10. FIG. 8 shows additional detail regarding the coupling between stiffener sleeve 41, rubber gasket sleeve 40, O-rings 42, and lined host pipe 10. Grooves 43 and notch 44 can be used to provide a better seal between stiffener sleeve 41 and lined host pipe 10. Groves 43 and notch 44 also provide greater versatility in that the same size of stiffener sleeve 41 can be used with different internal dimensions of lined host pipes 10. For example, variations in the thickness of the liner 11 can be accommodated by appropriate selection of O-rings 42.

In this embodiment, rubber gasket 21 is disposed around lined host pipe 10 at a location that is further from the edge of lined host pipe 10 than the embodiment shown in FIG. 3. However, the placement and shape of rubber gasket 21 can be easily applied to the embodiment shown in FIG. 3.

### C. Operation of Preferred Embodiment

This embodiment describes the use of an end-seal fitting as part of the repair of a lined pipe. However, the same process can be used when replacing a section of lined host pipe 10 to accommodate the addition of a branch line or other plumbing modification. FIG. 1 shows a lined host pipe 10 with liner 11 containing damage 12. The purpose of this embodiment is to repair the lined host pipe 10 with respect to damage 12. Initially, the damage 12 of lined host pipe 10 is removed by cutting lined host pipe 10 before and after the damaged section 12 to entirely remove the damaged section 12. Ideally, these cuts will be made perpendicular to lined host pipe 10. Although wheel type pipe cutters can be used, these types of cutters may leave a raised edge on the inside of the lined host pipe 10 which may prevent a water tight seal. In the embodiment shown in FIG. 1, lined host pipe 10 has already been cut at one location. Once the damaged section 12 of lined host pipe 10 has been removed, the liner 11 should be checked to make sure that it has not been damaged. If needed, liner 11 can be cut back approximately ⅛″ to remove any rough edges on the end of the liner 11.

Once the end of lined host pipe 10 has been prepared, the female threaded compression end 20 and its corresponding rubber gasket 21 can be slid over the end of lined host pipe 10, as shown in FIG. 4A. This can be followed by the insertion of rubber gasket sleeve 40 into the end of lined host pipe 10. It should sit substantially flat against the edge and interior of lined host pipe 10, as shown in FIG. 4B. After the rubber gasket sleeve 40 has been put in place, stiffener sleeve 41 can be inserted into the end of lined host pipe 10, as shown in FIGS. 4B and 4C. If necessary, rubber gasket sleeve 40 can be trimmed to be flush with the exterior of lined host pipe 10. Trimming can occur before or after the insertion of stiffener sleeve 41.

Once in place, stiffener sleeve 41 should compress the interior portion of rubber gasket sleeve 40 against the interior of lined host pipe 10. As such, this will generally be a tight fit. As such, it may be necessary to use soap and water as a lubricant to aid in the insertion of stiffener sleeve 41, although other lubricants can also be used. It may also to use a rubber mallet to insert stiffener sleeve 41 securely without damaging the lined host pipe 10 or any portion of the end-seal fitting.

After the rubber gasket sleeve 40 and stiffener sleeve 41 have been put in place, as shown in FIG. 4C, the male threaded compression end 30 can be slipped on to the end of lined host pipe 10, and coupled to female threaded compression end 20, as shown in FIG. 4D. Generally, this includes sliding the female threaded compression end 20 and rubber gasket 21 towards the end of lined host pipe 10 until it contacts male threaded compression end 30. At this point, the two compression ends 20, 30 can be screwed together to form a tight seal as shown in FIGS. 3 and 4D. This generally includes using a wrench to keep the female threaded compression end 20 in place while hand tightening the male threaded compression end 30 until they are properly sealed. Once the compression ends 20, 30 are sufficiently sealed, locking bolt 24 can be used to further secure the position of the end-seal.

Once completed, the rubber gasket 21 within the female threaded compression end 20 will be compressed against the male threaded compression end 30. The male threaded compression end 30 will be compressed against the stiffener sleeve 41. The stiffener sleeve 41 will be compressed against the rubber gasket sleeve 40. The rubber gasket sleeve 40 will be compressed against liner 11 and the end edge of the lined host pipe 10. The result should be a water tight seal at the end of the liner 11 on the inside of the lined host pipe 10. Once put in place, the damaged section of the lined host pipe 10 can be replaced using the fitting threads 32 on the male threaded compression end 30.

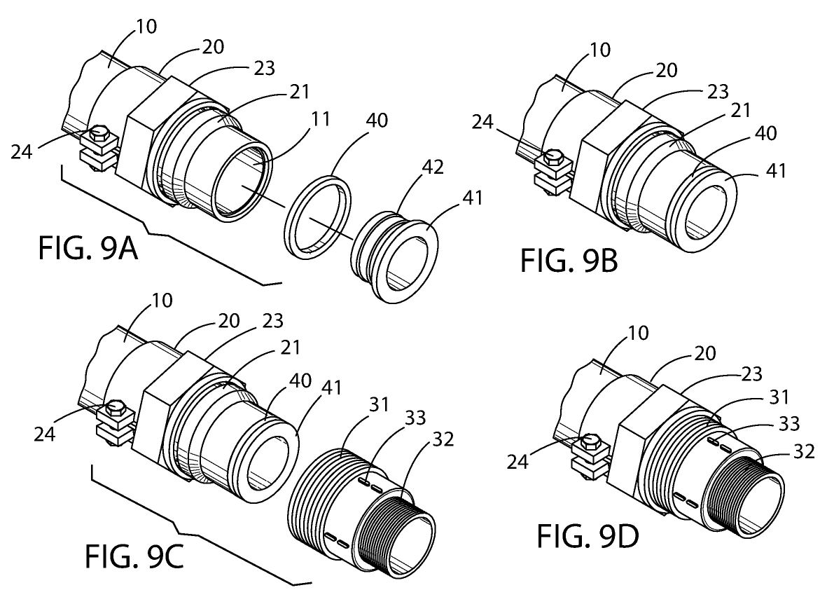

The embodiment shown in FIGS. 5 to 8 operates in a similar manner, as shown in FIGS. 9A to 9D. In this embodiment, rubber gasket sleeve 40 may be disposed around the exterior of stiffener sleeve 41 within notch 42 to be substantially flush with the outer edge of the lip 45 of stiffener sleeve 41. In some embodiments, rubber gasket sleeve 41 has an outer diameter that is slightly larger than the outer edge of the lip 45 of stiffener sleeve 41 to provide additional compression within male threaded compression end 30. Stiffener sleeve 41 with rubber gasket 40 attached can then be inserted into the end of lined host pipe 10 as shown in FIG. 8B. In other embodiments, rubber gasket 40 can be placed on the edge of lined host pipe 10 before stiffener sleeve 41 is inserted into rubber gasket 40 and lined host pipe 10 at substantially the same time. This embodiment also includes O-rings 42, which tighten the fit between stiffener sleeve 41 and lined host pipe 10. As with the embodiment shown in FIGS. 1 to 3, a rubber mallet can be used as needed.

After the rubber gasket sleeve 40 and stiffener sleeve 41 have been put in place, as shown in FIG. 9C, the male threaded compression end 30 can be slipped on to the end of lined host pipe 10, and coupled to female threaded compression end 20, as shown in FIG. 9D. Generally, this includes inserting lined host pipe 10 with attached rubber gasket sleeve 40 and stiffener sleeve 41 into male threaded compression end 30 until the end of lined host pipe 10 rests upon a lip within male threaded compression end 30. Female threaded compression end 30 and rubber gasket 21 are then slid towards the end of lined host pipe 10 until female threads 22 contact male threads 31. At this point, the two compression ends 20, 30 can be screwed together to form a tight seal as shown in FIGS. 7, 8, and 9D. This generally includes using a wrench to keep the female threaded compression end 20 in place while hand tightening the male threaded compression end 30 until they are properly sealed. Once the compression ends 20, 30 are sufficiently sealed, locking bolt 24 can be used to further secure the position of the end-seal.

The process above can be repeated to add an end-seal fitting to the portion of lined host pipe 10 that is opposite of the removed section. In other embodiments, an end-seal fitting is added to a replacement section of lined host pipe 10. Male threads 32 can be coupled to replacement portion of lined host pipe 10, a section of unlined host pipe, or one or more additional fittings, for example.

Unless otherwise defined, all technical and scientific terms used herein have the same meaning as commonly understood by one of ordinary skill in the art to which this invention belongs. Although methods and materials similar to or equivalent to those described herein can be used in the practice or testing of the pipe liner end seal fitting, suitable methods and materials are described above. All publications, patent applications, patents, and other references mentioned herein are incorporated by reference in their entirety to the extent allowed by applicable law and regulations. The pipe liner end seal fitting may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A method for attaching an end-seal fitting to a lined host pipe;
removing a section of the lined host pipe;
disposing a first compression end around an end of the lined host pipe;
disposing a gasket around the lined host pipe;
seating a gasket sleeve on the edge of the end of the lined host pipe;
inserting a stiffener sleeve into the gasket sleeve and into the lined host pipe;
seating the stiffener sleeve on the gasket sleeve;
placing a second compression end on the end of the lined host pipe in contact with the stiffener sleeve; and
coupling the first compression end to the second compression end, wherein the gasket is disposed between the first compression end and the second compression end.

2. The method of claim 1, wherein the first compression end is a first threaded compression end that comprises threads, the second compression end is a second threaded compression end comprising threads; and
wherein the step of coupling the first compression end to the second compression end comprises screwing the first threaded compression end together with the second threaded compression end.

3. The method of claim 2, wherein the first threaded compression end is a female threaded compression end, and the second threaded compression end is a male threaded compression end.

4. The method of claim 1, further comprising the step of securing the first compression end to the lined host pipe using a locking bolt.

5. The method of claim 1, wherein the gasket is a rubber gasket, and the gasket sleeve is a rubber gasket sleeve.

6. The method of claim 1, wherein the stiffener sleeve comprises at least one grove adapted to receive an O-ring, further comprising the step of disposing an O-ring around the stiffener sleeve within a grove in the stiffener sleeve

7. The method of claim 1, wherein the step of disposing a gasket around the lined host pipe; comprises disposing a gasket around the end of the lined host pipe.

8. The method of claim 1, wherein the stiffener sleeve is made of polyvinyl chloride.

9. The method of claim 1, wherein the stiffener sleeve comprises at least one notch; and
wherein the step of seating the stiffener sleeve on the gasket sleeve comprises disposing at least a portion of the gasket sleeve in at least one notch within the stiffener sleeve.

10. The method of claim 1, further comprising the step of trimming excess material from the gasket sleeve after it has been seated to make it substantially flush with the outer surface of the end of the lined host pipe.

11. A method for attaching an end-seal fitting to a lined host pipe, comprising:
removing a section of the lined host pipe containing the damaged section to create an end;
disposing a first threaded compression end around the end of the lined host pipe;
disposing a rubber gasket around the lined host pipe;
seating a rubber gasket sleeve on the edge of the end of the lined host pipe;
trimming excess material from the rubber gasket sleeve after it has been seated to make it substantially flush with the outer surface of the end of the lined host pipe;
seating a stiffener sleeve within the lined host pipe;
placing a second threaded compression end on the end of the lined host pipe; and
screwing the first threaded compression end together with the second threaded compression end, wherein the rubber gasket is disposed within the first threaded compression end and in contact with the second threaded compression end;
securing the first threaded compression end to the lined host pipe using a locking bolt.

12. A coupling between a lined host pipe and an end-seal fitting comprising:
a lined host pipe, comprising an end;
a female threaded compression end disposed around the end of the lined host pipe;
a rubber gasket disposed around the lined host pipe and within the female threaded compression end;
a rubber gasket sleeve seated on the edge of the end of the lined host pipe;
a stiffener sleeve seated within the rubber gasket sleeve and on the edge of the end of the lined host pipe;
a male threaded compression end that is threadably attached to the female threaded compression end; and
wherein the attachment between the female threaded compression end and the male threaded compression end keeps the rubber gasket, the rubber gasket sleeve, and the stiffener sleeve in a substantially fixed position.

13. The coupling of claim 12, wherein the female threaded compression end comprises a locking bolt, and the female threaded compression end is secured to the lined host pipe using the locking bolt.

14. The coupling of claim 12, wherein the female threaded compression end comprises a hexagonal section adapted for detachably coupling with a wrench.

15. The coupling of claim 12, wherein the rubber gasket is disposed around the end of the lined host pipe.

16. The coupling of claim 12, wherein the male threaded compression end comprises a grip adapted for tightening the attachment between the female threaded compression end and the male threaded compression end by hand.

17. The coupling of claim 12, wherein the female threaded compression end is comprised of brass, and the male threaded compression end is comprised of brass.

18. The coupling of claim 12, wherein the liner of the lined host pipe is comprised of polyethylene terephthalate.

19. The coupling of claim 12, wherein the lined host pipe is comprised of galvanized iron.

20. The coupling of claim 12, wherein the attachment between the female threaded compression end and the male threaded compression end is water tight.
